(19) United States
(12) Patent Application Publication
(10) Pub. No.: US 2007/0108105 A1
(43) Pub. Date: May 17, 2007

(54) Upflow shakers and separators

(76) Inventor: George Alexander Burnett, Aberdeen (GB)

Correspondence Address: Guy McClung, #114, 5315B F.M. 1960 Rd. West, Spring, TX, 77069-4410, US

(21) Appl. No.: 11/544,290

(22) Filed: Oct. 6, 2006

Related U.S. Application Data
(63) Continuation-in-part of application No. 11/280,875, filed on Nov. 17, 2005.
(63) Continuation-in-part of application No. 11/280,976, filed on Nov. 16, 2005.

(51) Int. Cl. B03B 7/00; B07B 9/00

(52) U.S. Cl. 209/17

(57) ABSTRACT

A separator system having a container, a screen apparatus with a box and at least one screen on the box, the at least one screen having a plurality of holes therethrough through which the liquid is passable and through which the solids are not passable, vibratory apparatus for vibrating the box and the screen(s), the material to be treated flowable up to the at least one screen and liquid in the material flowable to and through the at least one screen, a primary conveyor beneath the at least one screen for removing solids with liquid from the container and, optionally, movement apparatus for moving the solids including liquid from the container, and a secondary treatment system for further processing of the solids including liquid.

### CROSS-REFERENCE TO RELATED APPLICATIONS

This is: a continuation-in-part of U.S. application Ser. No. 11/280,875 filed Nov. 16, 2005 and a continuation-in-part of U.S. application Ser. No. 11/280,976 filed Nov. 16, 2005—all of which are incorporated fully herein and with respect to all of which the present invention claims priority under the Patent Laws.

### BACKGROUND OF THE INVENTION

1. Field Of The Invention

The present invention is directed to vibratory separators, and, in certain particular aspects, to upflow shale shakers and to upflow vibratory separators, and to methods of their use.

2. Description of Related Art

Vibratory separators are used in a wide variety of industries to separate materials such as liquids from solids or solids from solids. Typically such separators have a basket or other screen holding or mounting apparatus mounted in or over a receiving receptacle or tank and vibrating apparatus for vibrating the basket. One or more screens is mounted in the basket. Material to be treated is introduced to the screen(s) either by flowing it directly onto the screen(s) or by flowing it into a container, tank, or “possum belly” from which it then flows to the screen(s). Also in some multi-screen apparatuses material flows generally horizontally or uphill from one screen to another and, in certain systems, from an upper screen onto a lower screen.

FIG. 1 illustrates an apparatus according to the prior art, in which the debris laden mud 1 flows downwardly through a vibrating flat screen 2 to filter out the debris. The screen 2 is vibrated by vibrating the whole body of the apparatus using motors 3 with eccentric weights, for example. The cleaned mud exits the apparatus and then generally is ready for re-use. Debris that does not pass through the screen is caught on the screen and is carried by the direction and amplitude of the screen vibration upwardly towards an exit 4. Corrugated shaped screens have been used in the industry. In certain prior art screens the mud passes either vertically down through the screen, as is the case with the flat screens, or has a downward component to the flow, as is the case with certain three-dimensional screens. Arrangements have been proposed where the angle of the screen is increased and may be vertical in parts.

Examples of the general configuration of filter are disclosed in U.S. Pat. No. 4,459,207, WO-A-02 43 832 and WO-A-03 028 907.

### BRIEF SUMMARY OF THE INVENTION

The present invention discloses, in certain aspects, separator systems having a container; a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable; vibratory apparatus for vibrating the box and thereby vibrating the at least one screen; the material to be treated flowable to the at least one screen and liquid in the material flowable to and through the at least one screen into the box, at least part of the container disposed beneath the at least one screen; a material input for introducing the material into the container; a primary conveyor beneath the at least one screen for removing solids from the container, the solids including liquid; movement apparatus for receiving the solids including liquid from the primary conveyor and moving the solids including liquid from the container; and a secondary treatment system for receiving the solids including liquid from the movement apparatus and for further processing of the solids including liquid. In such a separator system the primary conveyor can be deleted and the movement apparatus can be used to move material to the secondary treatment system.

The present invention discloses, separator systems having a container; a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable; vibratory apparatus for vibrating the at least one screen; the material to be treated flowable to the at least one screen and liquid in the material flowable to and through the at least one screen, at least part of the container disposed beneath the at least one screen; a material input for introducing the material into the container; a transfer apparatus for transferring solids from the container; and wherein adjacent the or each screen of the at least one screen is an access door on the container for accessing and installing the at least one screen. In such a system, the screen(s) can be bowed (out or in).

In an upflow vibratory separator in which material to be treated flows up to a primary screen assembly in a box and fluid in the material flows up and through the primary screen assembly and solids in the material contact and do not flow through the primary screen assembly, the material flowing in and from a container, vibratory apparatus for vibrating the box and the primary screen assembly, at least part of the container disposed beneath the primary screen assembly, the improvement of a primary conveyor beneath the primary screen assembly for removing solids, the primary conveyor in one aspect having an auger inclined upwardly, and/or a deflector in the container for deflecting material away from the primary screen assembly.

The present invention, in certain aspects, discloses a vibratory separator system including a plurality of upflow vibratory separators, one adjacent the other, a common feed conduit for feeding material to be treated to the plurality of upflow vibratory separators, each upflow vibratory separator including a valve for selectively controlling the flow of the material thereto, each upflow vibratory separator an upflow vibratory separator according to the present invention.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWING

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1 is a diagram illustrating a prior art screening apparatus.

FIG. 2 is a diagram illustrating various mud flow paths in apparatus according to the invention.

FIG. 3 is a diagrammatic end view of an apparatus according to one exemplary embodiment of the invention.

FIG. 4 is a side view of the apparatus of FIG. 3.

FIG. 5 illustrates an alternative embodiment of the invention.

FIG. 6 illustrates yet another embodiment of the invention.

FIG. 7A is a schematic side cross-section view of a system according to the present invention.

FIG. 7B is a cross-section view of part of the system of FIG. 7A.

FIG. 7C an end view of the system of FIG. 7A.

FIG. 8 is a schematic side cross-section view of a system according to the present invention.

FIG. 9A is a schematic side cross-section view of a system according to the present invention.

FIG. 9B is an end view of the system of FIG. 9A.

FIG. 9C is a cross-section view of the system of FIG. 9A.

FIG. 10A is a schematic side cross-section view of a system according to the present invention.

FIG. 10B is an end view of the system of FIG. 10A.

FIG. 11 is a top schematic view of a system according to the present invention.

FIG. 12 is a schematic side cross-section view of a system according to the present invention.

FIG. 13 is an end cross-section view of a box according to the present invention.

FIG. 13A is a schematic side cross-section view of part of a system according to the present invention.

FIG. 14 is an end cross-section view of a box according to the present invention.

FIG. 15 is a side cross-section view of a system according to the present invention.

FIG. 15A is a side cross-section view of a system according to the present invention.

FIG. 15B is a side cross-section view of a system according to the present invention.

FIG. 16 is a side cross-section view of a system according to the present invention.

FIG. 17A is an end view of a system according to the present invention.

FIG. 17B is a cross-section view of a system according to the present invention.

Presently preferred embodiments of the invention are shown in the above-identified figures and described in detail below. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. In showing and describing the preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference.

### DETAILED DESCRIPTION OF THE INVENTION

FIGS. 1-4 present subject matter which the present invention improves.

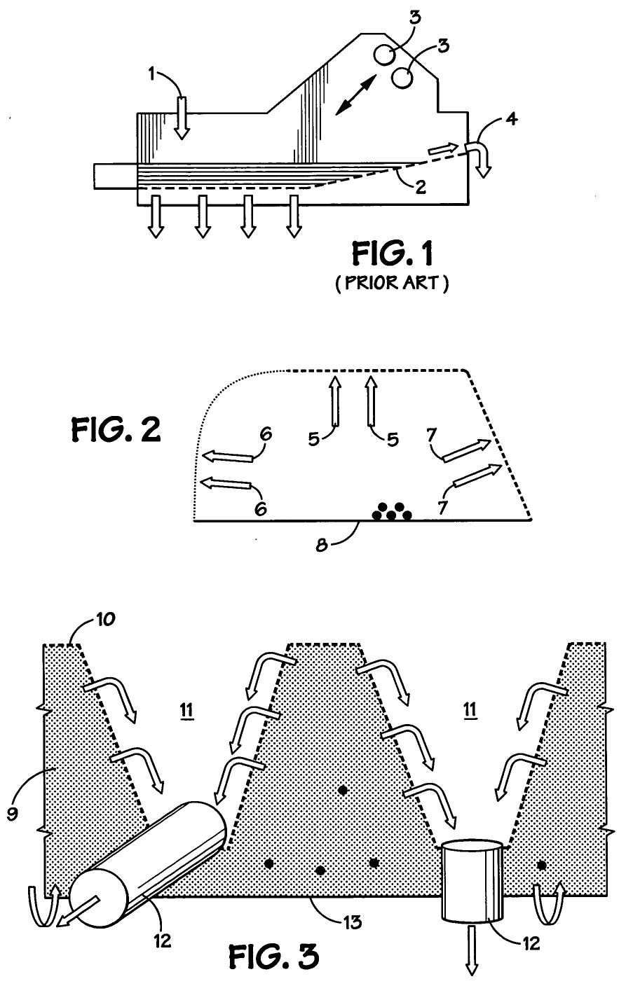

FIG. 2 shows new directions of flow for drilling fluid or mud with entrained debris. The mud passes through the screen either vertically 5, horizontally 6, or with an upward component 7. The debris falls under gravity to the lower surface 8 where it is conveyed out of the apparatus. The lower surface 8 may be a mesh screen, a roughened plate or a rotating belt or chain(s). The design of the apparatus is such that it is not possible for debris laden mud to bypass the screens. Unlike in certain prior art configurations, the mud is introduced into a compartment under the screens, not from above the screens. The pressure required to force the mud through the screen is provided by the height of a pool of mud adjacent to the screening compartment, although alternatively this could be provided for by other means such as a centrifugal pump.

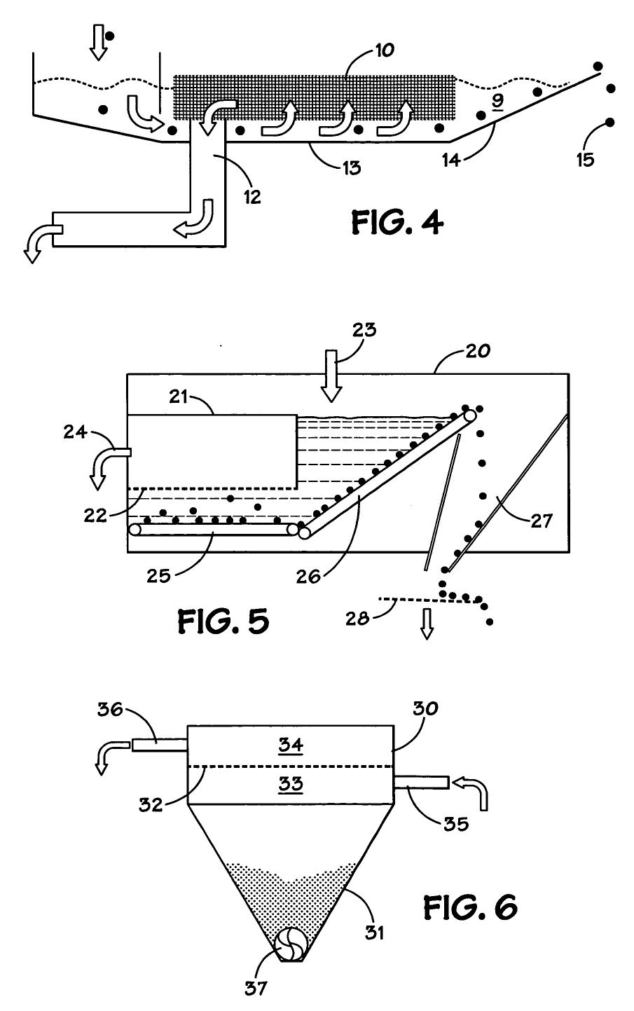

Referring now to FIGS. 3 and 4, debris-laden fluid or mud is introduced into a pool 9, and the fluid is forced through a vibrating screen 10 into a channel 11 that allows the substantially debris free mud to flow via pipe work or channels 12 to tanks for subsequent re-use. The cleaned mud may either exit the shakers from the sides or bottom of the shaker. The debris falls under gravity to a lower surface 13, which conveys the debris out from under the screen by vibration or via a moving belt. An inclined surface 14 conveys the debris out of the pool. This mode of conveyance may alternatively be a moving belt; however it is preferably similar to prior art inclined surfaces and consists of a vibrating screen which will assist the removal of mud from the debris. The debris 15 exiting the device may be sent to a screw press, centrifugal device or prior art shaker to further recover mud closely associated with the debris.

FIG. 5 shows an alternative arrangement, in which a main enclosure 20 contains a filter body 21 whose lowermost wall consists of a screen 22 which can be vibrated with the body 21 or independently thereof. In either case, the energy required to vibrate the screen is substantially smaller than would be required for vibration of the whole apparatus, as in the prior art apparatus. Debris-laden mud enters at 23 and the head of mud above the level of the screen 22 is sufficient to drive the mud through the screen into the body 21, from where it can flow out at 24 for re-use. Debris retained by the screen 22 is dislodged by the vibration and falls on to a horizontal conveyor belt 25, which carries it on to an inclined conveyor belt 26. This belt 26 carries the debris out of the mud and discharges it into a chute 27, from which it falls on to a secondary vibrating screen 28 arranged to remove residual mud for re-use before discharging the debris for disposal.

The embodiment of FIG. 6 has a filtration section 30 of uniform cross-section and a tapering section 31 beneath it. The filtration section 30 contains a vibrating screen 32 mounted so as to separate the filtration section into two sections: a lower inlet section 33 and an upper outlet section 34. The inlet section 33 is supplied with debris-laden mud via a supply pipe 35. The mud is pumped or otherwise supplied at a pressure sufficient to urge it upwardly through the vibrating screen 32 and into the outlet section 34, from where it flows for re-use through an outlet pipe 36.

Debris retained by the screen 32 falls into the tapering section 31, where it settles. An auger 37 is mounted in the lowermost part of the tapering section 31 and can be driven by an external motor (not shown) to urge the settled material out of the apparatus for disposal or further filtration or treatment as required to extract any residual liquid mud. In order to ensure that the minimum of liquid is removed in this manner, the tapering section 31 can be provided with a sensor to detect density or liquid content of the settled material above the auger 37 and to prevent operation of the external motor when the liquid content of the material adjacent to the auger is above a predetermined proportion, thereby preventing the loss of excess liquid mud.

It will be understood that, while the debris is represented in the drawings as discrete lumps or rock pieces, it will typically be a mixture of larger and smaller particles and pieces.

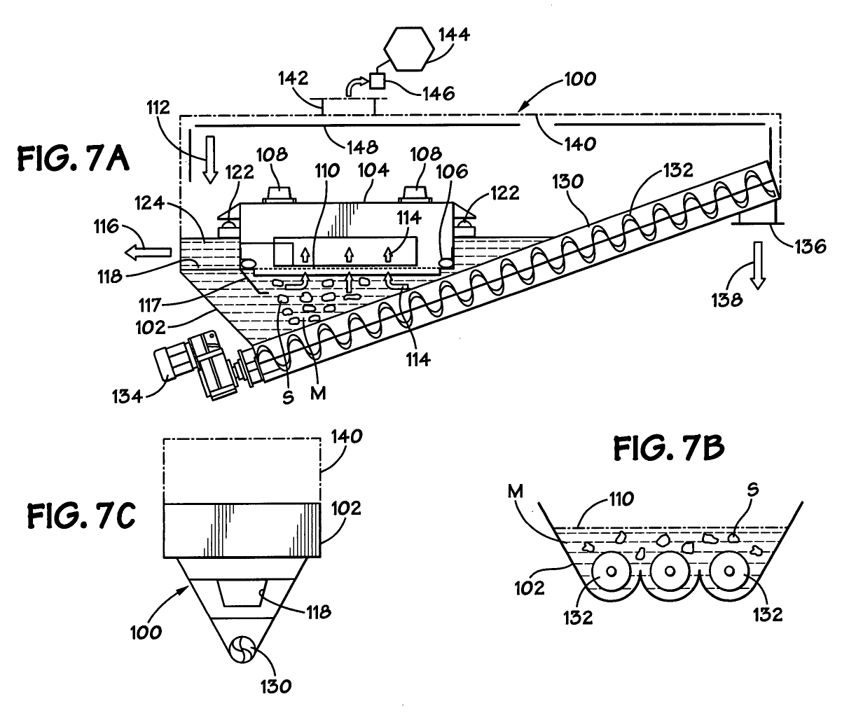

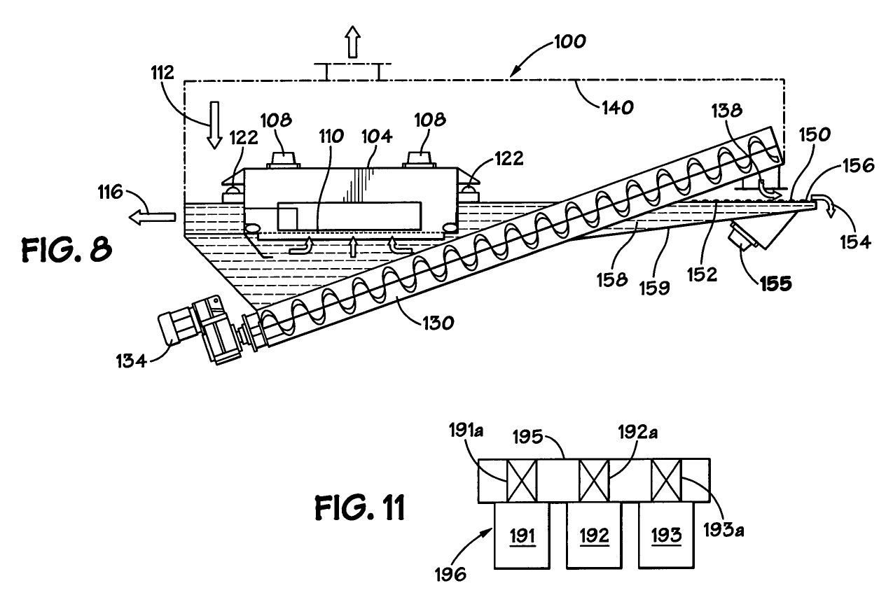

FIGS. 7A-7C illustrate a system 100 according to the present invention which has a housing 102 for containing material M to be treated. A screen apparatus 110 is removably secured to a box 104 which is mounted to the housing 102. Any known structure and/or apparatus may be used to removably secure the screen apparatus 110 to the box 104 and, as shown, in one aspect, a known inflatable seal apparatus 106 is used for this purpose.

Vibratory apparatus 108 connected to the box 104 vibrates the box 104 and thus the screen apparatus 110. Any suitable known vibratory apparatus may be used for the vibratory apparatus 108. Any suitable known screen or screens, screen assembly or screen assemblies may be used for the screen apparatus 110. The box 104 is mounted on anti-vibration mounts 122.

An arrow 112 indicates the introduction of the material M (including, but not limited to, drilling material including drilling fluid or mud, and drilled solids and debris) into the housing 102. Arrows 114 indicate the flow of the material M up to and through the screen apparatus 110. An arrow 116 indicates the discharge of recovered cleaned fluid 124 through a discharge duct 118 from the box 104 (shown schematically in FIG. 7C). In one aspect the duct 118 is flexible or has a flexible portion so that the duct 118 and the box 104 can be lowered in the housing 102, e.g. for access, maintenance, or cleaning. A deflector 117 directs incoming fluid flow. Heavier solids, directed by the deflector 117, will flow downwardly to the conveyor system 130 and will not impact the screen apparatus 110.

Solids S that do not pass through the screen apparatus 110 fall within the housing 102 and enter a conveyor system 130. An auger apparatus 132 rotated by a motor 134 augers the solids S up to a discharge opening 136. An arrow 138 indicates the flow of the material with discharged solids from the system 100 to storage, to disposal, or to additional processing.

According to the present invention, one, two, three, four, or more auger apparatuses may be used with a system according to the present invention; e.g. the system 100 as shown in FIG. 7B has three auger apparatuses 132. Optionally, the system 100 is enclosed with an enclosure 140. In one aspect air, fumes, gases, and/or material entrained in air above the box 104 are evacuated through an access opening 142. Optionally this is accomplished by an HVAC system 144 and/or a filtration system 146 with appropriate pumping apparatus and/or vacuum apparatus. Optionally the enclosure 140 itself or the enclosure 140 with sound insulation material 148 reduces noise from the system 100.

FIG. 8 illustrates one embodiment of the system 100 (and like numerals indicate like parts) which includes a screen apparatus 150 which receives the discharged material 138. It is within the scope of the present invention for the screen apparatus 150 to be inclined downwardly and for material to move off of it under the influence of gravity; or, as shown, in FIG. 8 the screen apparatus 150 includes vibratory apparatus 155 (like, e.g. the vibratory apparatus 108) which vibrates a screen or screens 152 (e.g. like the screen apparatus 110). Separated solids 154 flow off an exit end 156 of the screen(s) 152 and reclaimed fluid 158 flows to a receptacle or container 159.

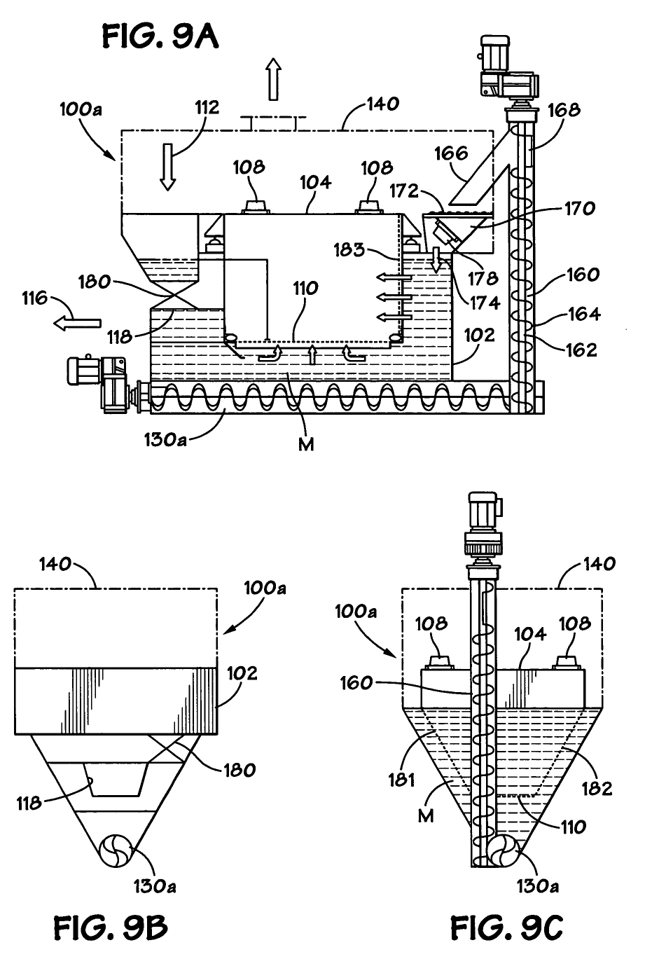

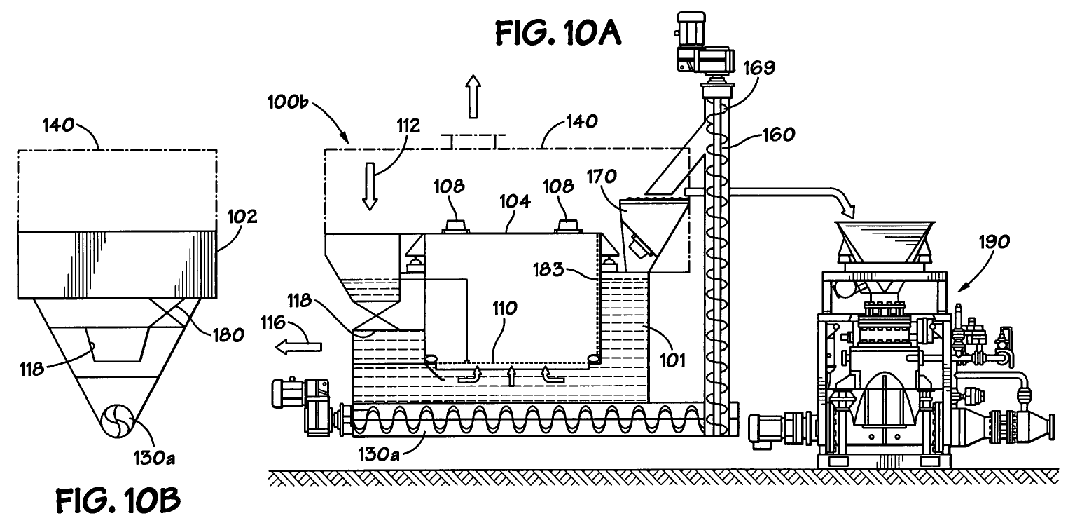

FIGS. 9A-9C illustrate an embodiment of a system 100 according to the present invention (like numerals indicate like parts) which includes at least one additional conveyor system 160 (like the conveyor system 130) which is oriented in a generally vertical orientation. A conveyor system 130a, like the system 130, may be oriented as shown in FIG. 7A or, as shown in FIG. 9A, may be oriented generally horizontally. The conveyor system 130a moves material with separated solids to the conveyor system 160 which, in turn, moves the material up to an exit duct 166. An optional paddle 168, secured to an auger apparatus 162 of the system 160 so that it is adjacent the duct 166, facilitates the movement of material into the exit duct 166. In one aspect the paddle 168 is a straight blade section on the auger apparatus 162 (as opposed to screw flights on the rest of the auger apparatus 162. Optionally, in one aspect a reversed flight 169 is used at the top of the auger apparatus (see, e.g. FIG. 10A) which moves material downwardly to the duct 166. Such a flight 169 can be used with the paddle 168.

Material with separated solids may, according to the present invention, flow to storage or to further processing or, as shown in FIG. 9A, may be introduced to a vibratory separator apparatus 170 with screening apparatus 172 (like the screening apparatus 110) vibrated by vibratory apparatus 178 (like the vibratory apparatus 108). It is within the scope of the present invention for the material with solids separated by the vibratory separator apparatus to flow to disposal, to storage, or to further processing. Reclaimed fluid from the vibratory separator apparatus 170 can be directed to storage or to a container; or, as shown in FIG. 9A by an arrow 174, it can flow back into the housing 102.

Optionally, a valve 180 selectively controls the flow of fluid into the housing 102. Optionally, in addition to (or instead of) the screen apparatus 110, one or more walls of the box 104 may have a screen mounted therein or thereon, or a screen or screens can be secured to the box 104. For example, as shown in FIG. 9C two inclined screens 181, 182 (like the screen apparatus 110) are secured to the box 104 and material M is flowable through the screens 181, 182 and through the screen apparatus 110. Additionally, and optionally, a further screen 183, oriented generally vertically, may be located to a vertical face 184 of the box 104.

In certain aspects, the use of an additional conveyor, such as the conveyor system 160, makes it possible for the material depth within the housing 102 to be increased as compared to a system with a lower conveyor system or systems. This can permit a screen apparatus to be set relatively deeper in a box which can result in side screens being taller so that more screening area is provided in a specified footprint area. In certain aspects according to the present invention, to empty a system as in FIG. 9A a height adjustment is made for both the box 104 and the duct 118.

FIG. 10A illustrates a system 100b like the system 100a of FIG. 9A (like numerals indicate like parts) which includes a solids conveying system 190. Solids separated by the vibratory separator apparatus 170 are introduced to the solids conveying system 190. In one particular aspect the solids introduced to the system 190 are drilled cuttings separated from a material that includes drilling fluid and drilled solids (“drilled cuttings”) and the system 190 is a drilled cuttings conveyance system. It is within the scope of the present invention to employ any suitable known cuttings conveyance system for the system 190.

As shown in FIG. 11 a system 196 according to the present invention may have a plurality of vibratory separators 191, 192, 193 (as any according to the present invention; in one aspect, each vibratory separator is a shale shaker processing drilling material). Material to be processed flows in a feed conduit or “gutter” 195 and each separator or shaker 191-193 has a flow valve 180a, 180b, 180c, respectively which selectively controls flow to each separator or shaker 191-193. Thus one, two or three separators or shakers 191-193 can be operational as desired. It is within the scope of the present invention to provide one, two, three, four, five, six or more separators or shakers in a system 196 according to the present invention.

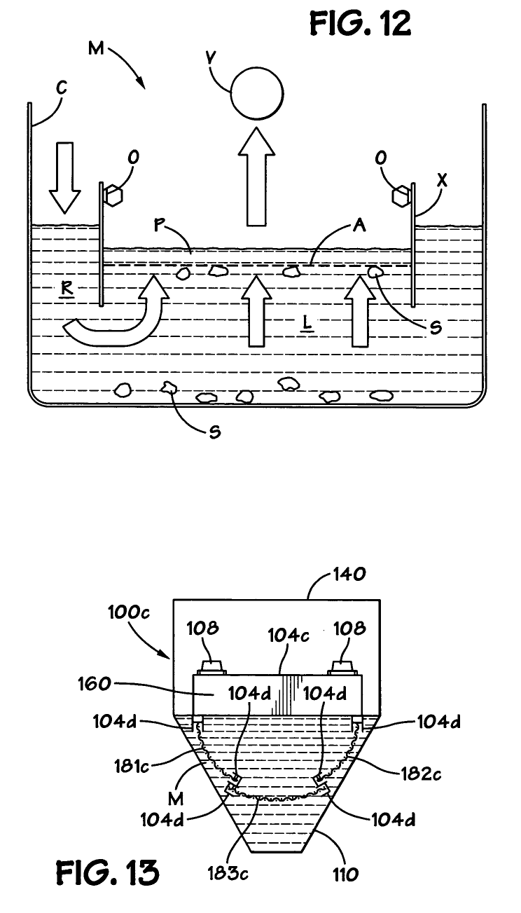

FIG. 12 shows a system M according to the present invention which has a container C into which material R is introduced, e.g. the material including liquid L and solids S. The material R flows to a screen apparatus A which is mounted in a basket or box X. Part P of the material, e.g. liquid or liquid plus some solids, flows up through the screen apparatus A. The part P is removed from the system by removal apparatus V (e.g. vacuum or pump apparatus). Part of the material, e.g. solids S and agglomerations or masses of solids, either settles down in the container C without contacting the screen apparatus A or, upon being prevented from further upward flow by the screen apparatus A and/or by material already adjacent the screen apparatus A, falls downwardly in the container C.

Electromagnetic vibrator apparatus 0 vibrates the basket X and, thus, the screen apparatus A. It is within the scope of the present invention to use one, two, three, four or more electromagnetic vibrator apparatuses (and to do so for any vibrator or vibration apparatus of any embodiment disclosed herein). It is within the scope of the present invention for the screen apparatus A (and the apparatus 110 described below) to be any suitable known screen or screen assembly used for vibratory separators or shale shakers. In one particular aspect the material R is drilling material with drilling fluid and drilled solids. Instead of, or in addition to, one or more electromagnetic vibrator apparatuses, according to the present invention, (as is true for any embodiment according to the present invention) one, two, three, four or more piezoelectric vibration apparatuses are used. Also, according to the present invention any vibrator or vibration apparatus of any embodiment according to the present invention may be connected directly to the screen apparatus instead of to the basket X. Appropriate mounts and/or isolators and/or shock absorbers O may be used to mount the vibrator or vibration apparatuses to a basket or directly to a screen apparatus.

It is within the scope of the present invention for any screen or screen assembly in any box or container of any system according to the present invention to be bowed, i.e., not flat across its extent (bowed inwardly or outwardly).

As shown in FIG. 13 a system 100c according to the present invention (like the systems 100, 100a, 100b—like numerals indicate like parts) a box 104c (like the box 104) has clamping apparatus 104d connected to the box 104 that releasably holds screens 181c, 182c and 183c in an outwardly bowed configuration. One, some or all of the screens or screen assemblies in a box can be bowed, outwardly or inwardly (e.g. as screen 183i in clamps 104i, FIG. 13A) or some combination of outward bowed and inward bowed screens.

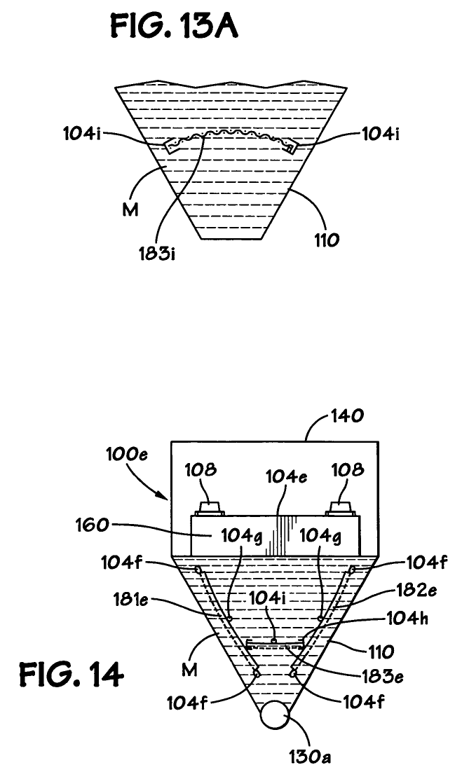

FIG. 14 shows a system 100e with a box 104e (like the system 100c and box 104c, but with differences discussed below; like numerals regarding the systems 100, 100a, 100b, and 100c indicate like parts). Inflatable bladder apparatus 104f associated with screens 181e and 182e bow these screens over central members 104g. Holding apparatus 104h holds a screen 183e bowed over a central member 104i.

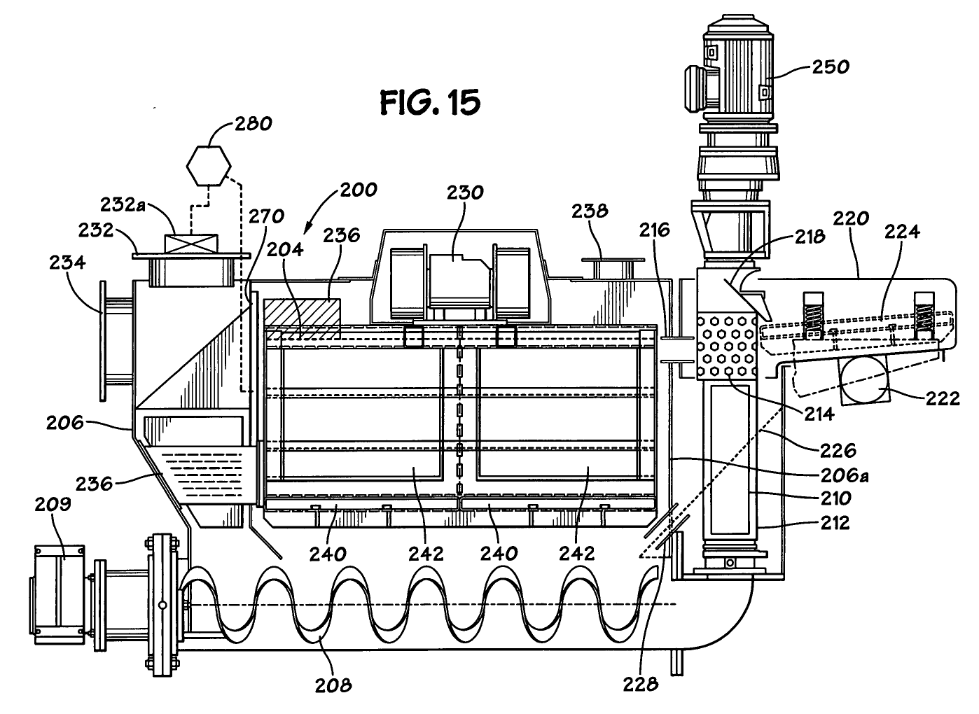

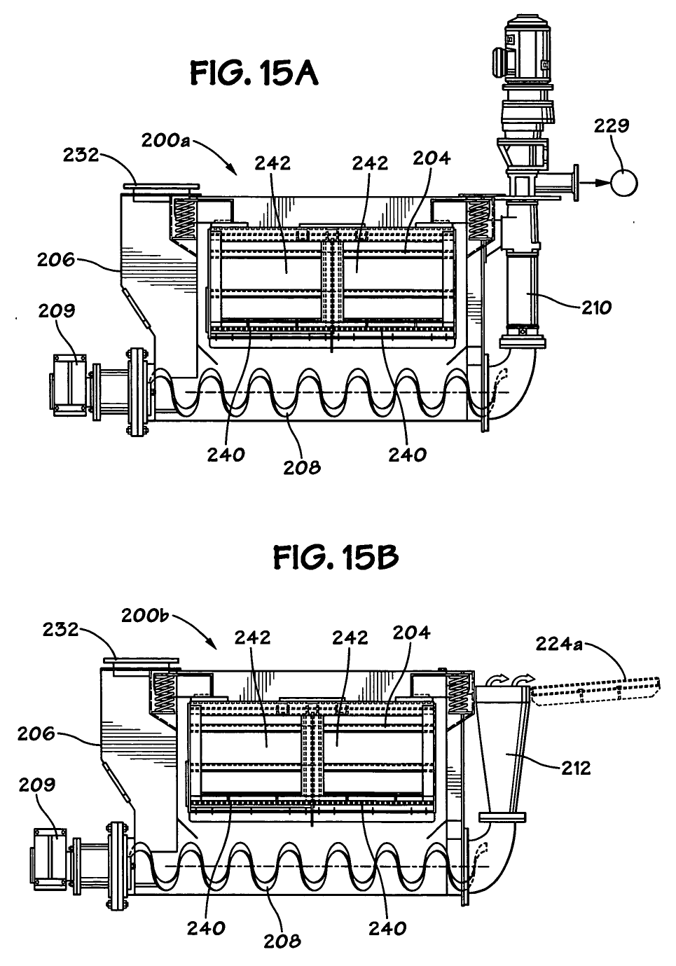

FIG. 15 shows a system 200 according to the present invention which has a box 204 according to the present invention (e.g. any box according to the present invention, e.g. like the boxes of FIGS. 7A, 8, 9A, 9C, 10A, 13, 14) removably secured within a basket 206. Separated material (with some liquid) flows down to an auger system 208 which moves the material to an optional apparatus 210 in a housing 212. The apparatus 210 may be a pump apparatus, a vertical lift apparatus or a mechanical mechanism for pushing material upwards.

Material flowing up in the housing 212 (in one aspect moved by the pump apparatus 210 driven by a motor 250) encounters a porous body 214 which permits liquid (e.g. drilling fluid from the material) to flow in a line 216 back into the basket 206. Solids (with some liquid) flow on a member 218 either out of the system for storage and/or further processing or, as shown, flow to a secondary shaker system 220. The porous body 214 insures that the fluid load onto the system 220 is minimized. The apparatus 210 is optional.

In the secondary shaker system 220 a motor 222 vibrates a screen or screens 224 mounted on isolation mounts. Liquid flowing down through the screens 224 flows down to a member 226 and then back into the basket 206 through a line 228. Solids (with some liquid) flow off the ends of the screen(s) 224 for collection, storage, and/or further processing. Alternatively the wall 206a is removed so reclaimed fluid is returned to the basket.

The basket 206 has primary inlet 232 and, optionally, an alternative or additional inlet 234 for material (e.g. drilling fluid with drilled solids entrained therein) to be treated by the system 200. Overflow is handled with a liquid overflow line 236 (from which it can pass into an adjacent system). Gases are vented through a vent connection 238. A motor 230 vibrates the basket 206 and the line 236 which is connected to the basket.

Screens 240 (at the bottom) and screens 242 (on the sides) are removably secured to the box 204 (two screens 242 on each box side).

A level sensor 270 senses the level of material in the basket 206 and sends a signal indicative of the level to a control system 280. The control system 280 processes these signals and controls basket speed and vibration which affects the feed of material into the basket 206. The control system 280 is used to maintain a desired level of material in the basket and for controlling an inlet valve 232a for controlling flow rate of material into the system.

The apparatus 210 and/or the secondary shaker 200 can be used with any system according to the present invention.

FIGS. 15A and 15B illustrate systems like the system 200 (FIG. 15), and like numerals indicate like parts.

In a system 200a of FIG. 15A, material moved upwardly from the auger system 208 by the apparatus 210 is transferred to another treatment system 229 (e.g. a centrifuge or centrifuges and/or a dryer or dryers, e.g. a vortex dryer).

In a system 200b of FIG. 15B, the apparatus 210 is omitted and the system 208 moves material up a conduit 212b from which it flows to a screen system 224a. Optionally, a system 229 (see FIG. 15B) is substituted for, or used in addition to, the screen system 224a.

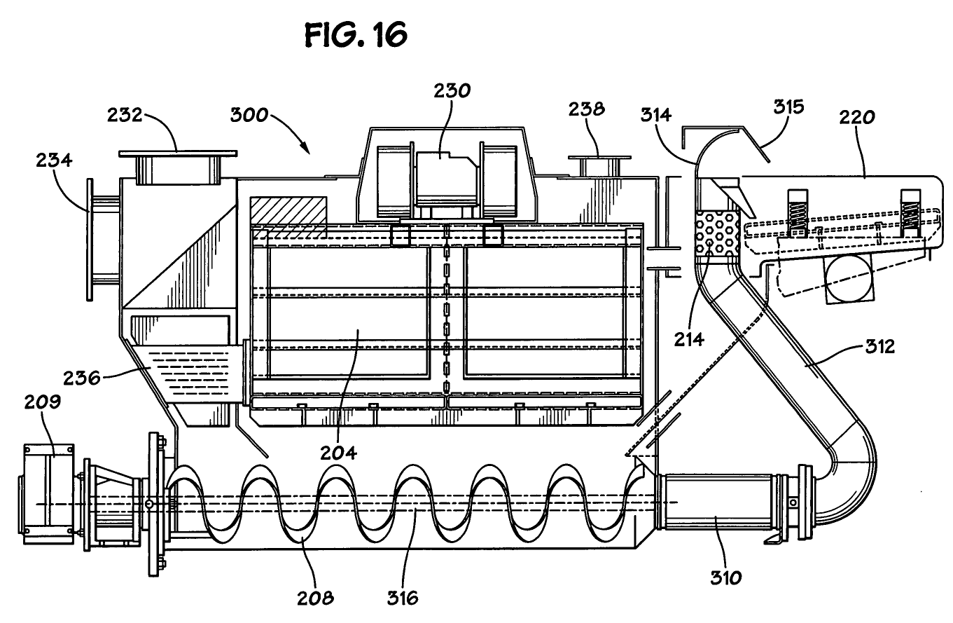

FIG. 16 shows a system 300 like the system 200 (like numerals indicate like parts) but without the apparatus 210. The auger 208 feeds material to an apparatus 310, e.g. a pump apparatus, which moves or pumps the material in a line 312 up to the porous body 214.

In one aspect the apparatus 210 or 310 is a pump apparatus, e.g. a MONO (trademark) pump from Mono Pumps Ltd. and in one particular aspect a MONOBLOC (trademark) B Range pump is used.

Material pumped upwardly past the porous body 214 is directed by members 314 and 316 to the secondary shaker 220. In certain aspects the auger 208 and the pump apparatus 310 each has its own dedicated motor drive system. As shown in FIG. 16, a single drive system 209 turns the auger 208 and drives the pump apparatus 310 via shaft 316.

In certain aspects the auger 208 is deleted and the pump apparatus 310 alone evacuates material from beneath the box 204 and transfers it into the line 312. It is within the scope of the present invention in any system disclosed herein to delete auger apparatus(es) (any one, two, or all) and replace it or them with a pump apparatus like the pump apparatus 310. Alternatively, the apparatuses 210 or 310 can be deleted from their systems.

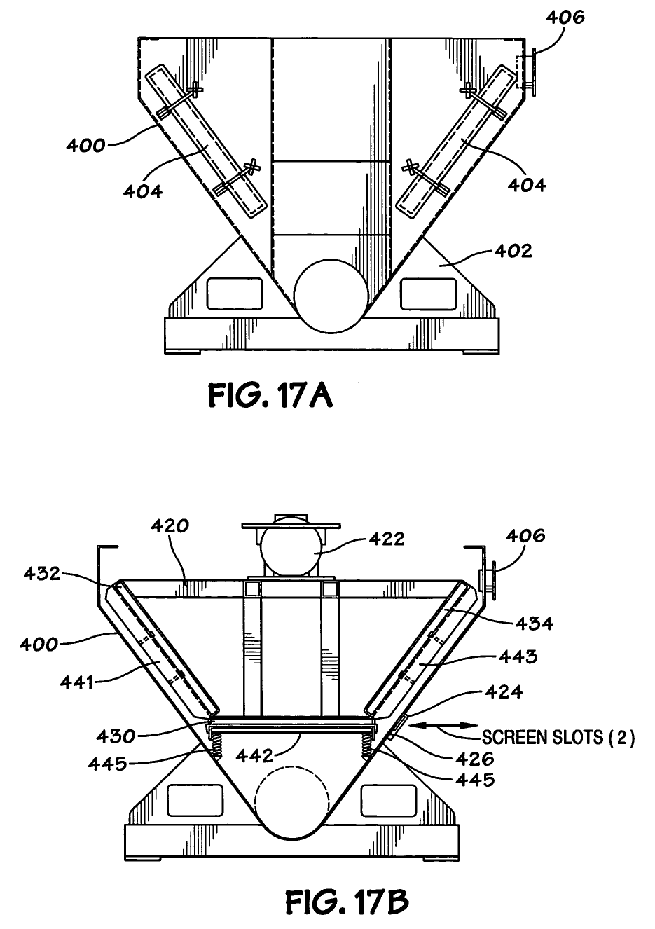

FIGS. 17A and 17B show an end view and a cross-section view, respectively, of certain embodiments of systems according to the present invention (which may, e.g., be employed in the systems of FIGS. 7A, 8, 9A-9C, 10A, 13, 14, 15 and/or 16).

A basket 400 (e.g. like the basket 206) on a base 402 has removable doors 404 which provide access to side screens on a box within the basket 400 and permit screen removal and installation. An overflow outlet 406 permits material to exit the basket 400 to prevent overflow of the basket 400.

FIG. 17B shows a box 420 within a basket 400 (a box which may be used with any system herein). The box 420 is vibrated by a motor or motors 422. A removable cover 424 over an opening 426 permits access to a lower screen 430. If two lower screens are present, another opening like the opening 426 with a cover like the cover 424 permits access to the additional screen. Side screens 432, 434 can be accessed through doors like the doors 404, FIG. 17A. Optionally, the screens are on screen carriers 441, 442, 443 and, via the doors 404 or the openings 426, an entire screen carrier with a screen thereon can be removed or installed. Doors like the doors 404 can be at either end or both ends of a box. The box 420 (as may be any box in any system according to the present invention) is mounted on one or more (two shown) spring isolation mounts 445 which rest on the basket. Optionally, the box may be suspended within the basket without contacting the basket.

The present invention, therefore, provides in certain, but not necessarily all embodiments, —in an upflow vibratory separator in which material to be treated flows up to a primary screen assembly in a box and fluid in the material flows up and through the primary screen assembly and solids in the material contact and do not flow through the primary screen assembly, the material flowing to the primary screen assembly, vibratory apparatus for vibrating the box and the primary screen assembly, at least part of the container disposed beneath the primary screen assembly, —a material input for introducing the material into the container, a deflector adjacent the material input for directing material flowing through the material input away from the primary screen assembly. Any such separator may include one or some, in any possible combination, of the following with or without the deflector: a primary conveyor beneath the primary screen assembly for removing solids ; locating conveyor means beneath the screen to carry the debris away from the screen; passing the separated debris through a further separation stage to remove entrained drilling fluid therefrom; conveyor means beneath the screen to carry the debris away from the screen; and/or separation means associated with the conveyor means for removing entrained mud from the debris; wherein the solids include liquid, the upflow vibratory separator further including separation apparatus for receiving solids conveyed by the primary conveyor, the separating apparatus for separating liquid from the solids; wherein the separation apparatus includes a secondary screen assembly for separating the solids from the liquid, the liquid flowing down through the secondary screen assembly; vibration apparatus for vibrating the secondary screen assembly; wherein the material is drilling material including drilling fluid and drilled solids; a secondary container for receiving and containing fumes from the material; evacuation apparatus for removing fumes from the secondary container; filtration apparatus for filtering fumes from the secondary container; the primary screen assembly mounted generally horizontally, and at least one tertiary screen assembly mounted non-horizontally for treating the material; wherein the at least one tertiary screen assembly is two spaced-apart tertiary screen assemblies, each extending upwardly from the primary screen assembly; a valve for controlling flow of material into the container; secondary conveyor for receiving the solids conveyed by the primary conveyor and for conveying the solids away from the primary conveyor, the solids including liquid; wherein the secondary conveyor has an exit through which solids including liquid exit for further processing; the secondary conveyor including auger apparatus for moving the solids including liquid to the exit; a paddle on the auger apparatus for moving solids including liquid to the exit; secondary vibratory separator apparatus for receiving solids including liquid from the exit of the secondary conveyor and for treating the solids including liquid, the secondary vibratory separator apparatus for producing separated solids and for producing liquid for introduction back into the container; solids conveying apparatus for receiving the solids from the secondary vibratory separator apparatus and for conveying the solids away from the upflow vibratory separator; and/or the primary conveyor including a plurality of spaced-apart auger apparatuses for moving the solids away from the upflow vibratory separator.

The present invention, therefore, provides in certain, but not necessarily all embodiments, a vibratory separator system including a plurality of upflow vibratory separators, one adjacent the other, a common feed conduit for feeding material to be treated to the plurality of upflow vibratory separators, each upflow vibratory separator including a valve for selectively controlling the flow of the material to a corresponding upflow vibratory separator, each upflow vibratory separator as any upflow vibratory separator according to the present invention.

The present invention, therefore, provides in certain, but not necessarily all embodiments, a method for treating material with an upflow vibratory separator, the upflow vibratory separator as any disclosed herein according to the present invention with conveyor apparatus, the method including flowing the material to the primary screen assembly and with the primary screen assembly filtering out solids from the material, the solids flowing downwardly in the container, and vibrating a screen or screen assembly with non-motorized vibration apparatus.

The present invention, therefore, provides in certain, but not necessarily all embodiments, a separator system having a container; a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable; vibratory apparatus for vibrating the box and thereby vibrating the at least one screen; the material to be treated flowable to the at least one screen and liquid in the material flowable to and through the at least one screen, at least part of the container disposed beneath the at least one screen; a material input for introducing the material into the container; a primary conveyor beneath the at least one screen for removing solids from the container, the solids including liquid; movement apparatus for receiving the solids including liquid from the primary conveyor and moving the solids including liquid from the container; and a secondary treatment system for receiving the solids including liquid from the movement apparatus and for further processing of the solids including liquid. Such a system may include one or some, in any possible combination, of the following: the secondary treatment system is any of a centrifuge, a dryer, or a screening system; the movement apparatus moving the solids including liquid in a conduit to the secondary treatment system; the conduit including an exit portion from which liquid from the solids including liquid may exit the conduit to reduce a liquid load on the secondary treatment system; wherein liquid is flowable from the exit portion to the container; wherein the exit portion is a porous body part of the conduit; the at least one screen is a plurality of screens on the box; wherein the at least one screen is bowed (inwardly or outwardly); wherein bladder apparatus maintains the at least one screen in a bowed configuration; wherein adjacent the or each screen of the at least one screen is an access door on the container for accessing and installing the at least one screen; the movement apparatus is any of a vertical lift apparatus, a pump apparatus, or a mechanical mechanism for pushing material; the secondary system separates liquid from the solids including liquid thereby producing separated liquid, the separator system further having flow apparatus for flowing the separated liquid to the container; a control system for controlling rate of flow of material into the container; wherein the secondary treatment system is pump apparatus and the separator system further is a single drive system for driving both the primary conveyor and the pump apparatus; and/or wherein the screen apparatus is mounted on spring isolation mounts in the container.

The present invention, therefore, provides in certain, but not necessarily all embodiments, a separator system having a container; a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable; vibratory apparatus for vibrating the box and thereby vibrating the at least one screen; the material to be treated flowable to the at least one screen and liquid in the material flowable to and through the at least one screen, at least part of the container disposed beneath the at least one screen; a material input for introducing the material into the container; a primary conveyor beneath the at least one screen for removing solids from the container, the solids including liquid; movement apparatus for receiving the solids including liquid from the primary conveyor and moving the solids including liquid from the container; a secondary treatment system for receiving the solids including liquid from the movement apparatus and for further processing of the solids including liquid; the secondary treatment system is any of a centrifuge, a dryer, or a screening system; the at least one screen is a plurality of screens on the box; and the movement apparatus is any of a vertical lift apparatus, a pump apparatus, or a mechanical mechanism for pushing material.

The present invention, therefore, provides in certain, but not necessarily all embodiments, a separator system having a container; a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable; vibratory apparatus for vibrating the box and thereby vibrating the at least one screen; the material to be treated flowable to the at least one screen and liquid in the material flowable to and through the at least one screen, at least part of the container disposed beneath the at least one screen; a material input for introducing the material into the container; movement apparatus for moving solids including liquid from the container; and a secondary treatment system for receiving the solids including liquid from the movement apparatus and for further processing of the solids including liquid.

The present invention, therefore, provides in certain, but not necessarily all embodiments, a container; a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable; vibratory apparatus for vibrating the box and thereby vibrating the at least one screen; the material to be treated flowable to the at least one screen and liquid in the material flowable to and through the at least one screen, at least part of the container disposed beneath the at least one screen; a material input for introducing the material into the container; a primary conveyor beneath the at least one screen for removing solids from the container, the solids including liquid; and wherein adjacent the or each screen of the at least one screen is an access door on the container for accessing and installing the at least one screen.

The present invention, therefore, provides in certain, but not necessarily all embodiments, a container; a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable; vibratory apparatus for vibrating the box and thereby vibrating the at least one screen; the material to be treated flowable to the at least one screen and liquid in the material flowable to and through the at least one screen, at least part of the container disposed beneath the at least one screen; a material input for introducing the material into the container; a primary conveyor beneath the at least one screen for removing solids from the container, the solids including liquid; and wherein the at least one screen is bowed (inwardly or outwardly; or with multiple screens all bowed inwardly, all bowed outwardly, or at least one bowed outwardly and at least one bowed inwardly).

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112. The inventor may rely on the Doctrine of Equivalents to determine and assess the scope of their invention and of the claims that follow as they may pertain to apparatus not materially departing from, but outside of, the literal scope of the invention as set forth in the following claims. Any patent or patent application referred to herein is incorporated fully herein for all purposes.

What is claimed is:

1. A separator system comprising
a container,
a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable,
vibratory apparatus for vibrating the box and thereby vibrating the at least one screen,
the material to be treated flowable to the at least one screen and liquid in the material flowable to and through the at least one screen, at least part of the container disposed beneath the at least one screen,
a material input for introducing the material into the container,
a primary conveyor beneath the at least one screen for removing solids from the container, the solids including liquid,
movement apparatus for receiving the solids including liquid from the primary conveyor and moving the solids including liquid from the container, and
a secondary treatment system for receiving the solids including liquid from the movement apparatus and for further processing of the solids including liquid.

2. The separator system of claim 1 wherein the secondary treatment system comprises any of a centrifuge, a dryer, or a screening system.

3. The separator system of claim 1 further comprising
the movement apparatus moving the solids including liquid in a conduit to the secondary treatment system,
the conduit including an exit portion from which liquid from the solids including liquid may exit the conduit to reduce a liquid load on the secondary treatment system.

4. The separator system of claim 3 wherein liquid is flowable from the exit portion to the container.

5. The separator system of claim 4 wherein the exit portion is a porous body part of the conduit.

6. The separator system of claim 1 wherein
the at least one screen is a plurality of screens on the box.

7. The separator system of claim 1 wherein the at least one screen is bowed.

8. The separator system of claim 7 wherein the at least one screen is bowed outwardly.

9. The separator system of claim 7 wherein the at least one screen is bowed inwardly.

10. The separator system of claim 7 wherein bladder apparatus maintains the at least one screen in a bowed configuration.

11. The separator system of claim 1 wherein adjacent the or each screen of the at least one screen is an access door on the container for accessing and installing the at least one screen.

12. The separator system of claim 1 wherein
the movement apparatus comprises any of a vertical lift apparatus, a pump apparatus, or a mechanical mechanism for pushing material.

13. The separator system of claim 1 wherein
the secondary system separates liquid from the solids including liquid thereby producing separated liquid,
the separator system further comprising
flow apparatus for flowing the separated liquid to the container.

14. The separator system of claim 1 further comprising
a control system for controlling rate of flow of material into the container.

15. The separator system of claim 1 wherein the secondary treatment system comprises pump apparatus and the separator system further comprises
a single drive system for driving both the primary conveyor and the pump apparatus.

16. The separator system of claim 1 wherein the screen apparatus is mounted on spring isolation mounts in the container.

17. A separator system comprising
a container,
a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable,
vibratory apparatus for vibrating the box and thereby vibrating the at least one screen,
the material to be treated flowable to the at least one screen and liquid in the material flowable to and through the at least one screen, at least part of the container disposed beneath the at least one screen,
a material input for introducing the material into the container,
a primary conveyor beneath the at least one screen for removing solids from the container, the solids including liquid,
movement apparatus for receiving the solids including liquid from the primary conveyor and moving the solids including liquid from the container,
a secondary treatment system for receiving the solids including liquid from the movement apparatus and for further processing of the solids including liquid,
the secondary treatment system comprises any of a centrifuge, a dryer, or a screening system,
the at least one screen is a plurality of screens on the box, and
the movement apparatus comprises any of a vertical lift apparatus, a pump apparatus, or a mechanical mechanism for pushing material.

18. A separator system comprising
a container,
a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable,
vibratory apparatus for vibrating the box and thereby vibrating the at least one screen,
the material to be treated flowable to the at least one screen and liquid in the material flowable to and through the at least one screen, at least part of the container disposed beneath the at least one screen,
a material input for introducing the material into the container,
transfer apparatus for transferring solids including liquid from the container, and
a secondary treatment system for receiving the solids including liquid from the transfer apparatus and for further processing of the solids including liquid.

19. A separator system comprising
a container,
a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable,
vibratory apparatus for vibrating the box and thereby vibrating the at least one screen,
the material to be treated flowable to the at least one screen and liquid in the material flowable to and through the at least one screen, at least part of the container disposed beneath the at least one screen,
a material input for introducing the material into the container,
a transfer apparatus for transferring solids from the container, the solids including liquid, and
wherein adjacent the or each screen of the at least one screen is an access door on the container for accessing and installing the at least one screen.

20. A separator system comprising
a container,
a screen apparatus in the container, the screen apparatus comprising a box and at least one screen on the box for screening material introduced into the container, the material containing liquid and solids, the at least one screen having a plurality of holes therethrough through which the liquid is passable and through which the solids are not passable,
vibratory apparatus for vibrating the box and thereby vibrating the at least one screen,
the material to be treated flowable to the at least one screen and liquid in the material flowable to and through the at least one screen, at least part of the container disposed beneath the at least one screen,
a material input for introducing the material into the container,
a transfer apparatus for transferring solids from the container, the solids including liquid, and
wherein the at least one screen is bowed.
